(19) United States
(12) Patent Application Publication
(10) Pub. No.: US 2007/0051933 A1
(43) Pub. Date: Mar. 8, 2007

(54) Force applying apparatus and method

(76) Inventor: Richard G. Rincoe, Ephrata, WA (US)

Correspondence Address: MARTIN & HENSON, P.C., 9250 W 5TH AVENUE, SUITE 200, LAKEWOOD, CO, 80226, US

(21) Appl. No.: 10/568,547

(22) PCT Filed: Jun. 24, 2004
(86) PCT No.: PCT/US04/20501

§ 371 Date: Feb. 15, 2006

Related U.S. Application Data
(60) Provisional application No. 60/482,464, filed on Jun. 24, 2003.

(51) Int. Cl. B60S 9/02

(52) U.S. Cl. 254/425

(57) ABSTRACT

A force applying apparatus includes a housing that supports a drive motor. A first extendable member is telescopically received in the housing and moves between a retracted position within the housing and an extended position axially of the housing. A second extendable member is telescopically received in the first extendable member and moves between a contracted position within the first extendable member and an expanded position axially of the first extendable member. The motor drives a ring gear that advances the first extendable member, and a ball nut is mounted in the end of the first extendable member to advance the second extendable member. A spline helps retain the first and second extendable members against rotation but a detent assembly selectively releases the first extendable member for rotation. The apparatus may be used to lift and level a recreational vehicle. A method implemented by this structure is also claimed.

### FIELD OF THE INVENTION

The present invention generally relates to force applying apparatus that applies a force between two locations, for example, between an object and a surface. The invention particularly concerns force applying apparatus that may be motor driven. The invention is particularly directed to a lifting apparatus in the form of a leveling jack such as that used in the recreational vehicle industry. The invention also relates to a method of applying a force.

### BACKGROUND OF THE INVENTION

A wide variety of different mechanical devices have been developed to apply force between two locations, for example, between an object and a surface or between two objects. Such devices are used to obtain a mechanical advantage in the lifting or moving of heavy objects. One such apparatus is referred to as a “jack” which is usually a portable device that may move from a collapsed state to an extended state wherein a load is moved by the apparatus against the force of gravity.

Mechanical jacks typically come in three types, lever operated devices, screw operated devices or hydraulic press devices. A lever jack uses the principle of a small force over a large distance to elevate a heavy load over a small distance. Ratchets are provided so that the mechanical advantage of the lever may be sequentially applied to elevate the load a desired amount within the jack's throw distance. Screw jacks, on the other hand, gain mechanical advantage by use of a thread wherein rotary movement advances a screw to move the load. Hydraulic jacks implement the advantage of a pressurized fluid to move an extendable support member.

One application of a jack mechanism is in the recreational vehicle industry. Here, it is known to use leveling jacks in order to stabilize a recreational vehicle, such as an RV trailer, for occupancy and use. Typical stabilizer jacks operate on a hydraulic system. Such jacks have many disadvantages. One such disadvantage is the magnitude of the length of the jack necessary in order to get a sufficient throw distance for the moveable load-bearing member. These jacks are also heavy so that they are difficult and awkward to secure to the vehicle. Moreover, due to the use of hydraulic fluid, the control systems for these jacks can be complicated and may be prone to the undesirable leakage of hydraulic fluid.

### OBJECTS OF THE INVENTION

It is an object of the present invention to provide a new and useful device and method that provides mechanical advantage in applying a force between two locations, objects or an object and a surface, such as encountered with a recreational vehicle.

A further object of the present invention is to provide a new and useful device and method for lifting or otherwise moving heavy loads.

Another object of the present invention is to provide a compact mechanism that has an improved range of operability notwithstanding its compact size.

Still another object of the present invention is to provide a lift apparatus that can lift heavy loads, yet which relies on a limited number of parts and constructions.

Still a further object of the present invention is to provide a jack assembly that may be used as a load stabilizer for trailers, recreational vehicles and the like.

Yet another object of the present invention is to provide a mechanical assembly for use in leveling loads which is easy to install and simple to maintain.

It is yet a further object of the present invention to provide a device and method that incorporates safety limit switches.

According to the present invention, then, an apparatus is provided to apply a force, for example, between two objects, between two locations, or between an object and a support surface. Broadly, the apparatus includes a housing having a housing interior. An elongated first extendable member and an elongated second extendable member, respectively having first and second thread structures, are provided. The first and second extendable members are telescopically disposed with respect to one another and are moveable relative to one another between a contracted position and an expanded position. The first and second elongated members together are telescopically received in the housing. A first threaded drive element has a first thread drive of a first thread pitch and is operative to engage the first thread structure of the first extendable member thereby to advance the first extendable member between an extended position and a retracted position relative to the housing. A second threaded drive element has a second thread drive of a second thread pitch and is operative to engage the second thread structure of the second extendable member thereby to advance the first and second extendable members between a contracted position wherein the second extendable member is telescopically received in the first extendable member and an expanded position wherein the second extendable member extend outwardly of the first extendable member. A drive is then operative in a first mode to actuate the first and second threaded drive elements whereupon the first extendable member is advanced between the retracted position and the extended position and the second extendable member is advanced from the contracted position to the expanded position. In a second mode of operation, the drive is operative to actuate the first and second threaded drive elements whereby the first extendable member is advanced between the extended position and the retracted position and the second extendable member is advanced from the expanded position to the contracted position.

In its more detailed form, the housing includes a housing sidewall that extends between first and second housing end portions. A lift gear is disposed in the second housing end portion and includes lift threads having a first thread pitch. Here, an elongated first extendable member is sized and adapted to be telescopically received in the housing interior. The first extendable member includes a first sidewall that has a cylindrical outer surface that extends between a first captured end and a first free end. This first sidewall is provided with first threads sized and adapted to engage the lift threads of the lift gear. A threaded drive element is then disposed in the interior of the first member at a location proximate to the first free end thereof. The studded drive element has a drive thread of a second thread pitch. Elongated second extendable member is then sized and adapted to be telescopically received in the first member interior. The second extendable member includes a second sidewall having a cylindrical outer surface extending between a second captured end a second free end. The second sidewall is then provided with second threads sized and adapted to engage the thread drive.

The drive may be a reversible motor so as to expand the apparatus and contract the apparatus. In its more detailed form, the motor turns a drive gear that engages the lift gear. Rotation of the lift gear in a first rotational direction acts first to advance the extendable member between the retracted position when the first extendable member is telescopically received in the housing interior and an extended position when the first extendable member extends longitudinally outward of the housing. Continued rotation of the lift gear in the first rotational direction when the first extendable member is in the extended position acts to rotate the first extendable member and the threaded drive element therein in the first rotational direction. Accordingly, the second extendable member is then advanced between a contracted position wherein the second extendable member is telescopically received in the first member interior and an expanded position wherein the second extendable member extends longitudinally outwardly of the first extendable member. Rotation of the lift gear in a second rotational direction when the first extendable member is extended acts to rotate the first extendable member and the threaded drive element in the second rotational direction so that the second extendable member is advanced from the expanded position to the contracted position. Continued rotation of the lift gear in the second rotational direction when the second extendable member is in the contracted position acts to advance the first extendable member from the extended position to the retracted position.

In order to facilitate proper sequencing of the extension and expansion as well as the contraction and retraction, a spline assembly is provided to interface the second extendable member with the internal sidewall of the housing. Here, the spline assembly includes a shaft portion that is slideably engaged with the second extendable member and a head portion that interfaces with the housing. The head portion is operative to resist rotation of the second extendable member relative to the housing. However, the head portion may include a detent operative to rotation of the head relative to the housing upon a rotational force in excess of a selected maximum. Further, the second extendable member may include a key way that extends longitudinally therein. The shaft portion is then slidably received in the key way. The internal sidewall of the housing can include at least one longitudinally extending groove formed therein with this groove being sized and adapted to engage the ball detent.

In order to further insure proper operation of the apparatus, a detent assembly interfaces the first and second extendable members. Here, the detent assembly acts with a first force resisting disengagement of the first and second extendable members for movement of the second extendable member from the contracted position to the extended position. It acts with a second force permitting reengagement of the first and second extendable members when the second extendable member is moved from the expanded position to the contracted position. The first force is selected to be greater than the second force. One mechanism to accomplish this is a spring biased detent member located on one of the first and second extendable members and a spring biased gate on another of the first and second extendable members.

In the disclosed embodiment, the lift gear is disclosed to be a ring gear, and the threaded drive in the first extendable member is a ball nut. Moreover, it is desired that the first and second thread pitches be different from one another so that the first extendable member advances a greater distance than the second extendable member for a given number of rotations of the lift gear. Moreover, various sensors are provided to detect the position of the first extendable member and the second extendable member. For example, an extension sensor is operative to detect when the first extendable member is in the extended position. A contact sensor is operative to detect when the first and second extendable members begin to apply a force on an object that is in excess of threshold amount. A retraction sensor is provided and is operative to detect when the first extendable member is in the retracted position. A drive gear sensor may also be provided that is operative to monitor the amount of rotation of the drive gear.

In order to protect the apparatus against the ingress of dirt, debris, etc., a boot may be provided between the housing and the free end of the second extendable member. Here, if desired, the second end of the extendable member may be provided with a foot portion that is secured thereto by means of a connection that is moveable about at least two axis of motion. The boot member is then connected between the foot member and the housing and, in the illustrated embodiment, is an accordion like tube that allows for extension and expansion of the first and second extendable members.

The present invention is also directed to a method of applying a force between two locations, such as between and object and a surface, two objects and the like. Broadly the method includes securing a housing at a first location wherein the housing telescopically receives a first extendable member and wherein the first extendable member telescopically receives a second extendable member. The method then includes the step of mechanically advancing the first extendable member at a first rate of extension from a retracted position within the housing to an extended position wherein the first and second extendable members extend axially outwardly of the housing. The method then includes the step of mechanically advancing the second extendable member at a second rate from a contracted position within the first extendable member to an expanded position wherein the second extendable member extends actually outwardly of the first extendable member. In this method, the first rate of advancement is faster than the second rate of advancement.

According to the disclosed method, the step of advancing the first extendable member is completed before beginning the step of advancing the second extendable member. The method may include the step of monitoring the advancement of the second extendable member to determine if it makes contact with the second location. Here, the method may include a further step of advancing the second extendable member for a predetermined distance after the second extendable member makes contact with the second location. In another variation, the method may include the step of monitoring the advancement of the second extendable member for resistance that occurs before the second extendable member has advanced toward the expanded position for a pre-selected minimum distance. Here, the method includes the step of disabling advancement of the second extendable member should resistance be detected before reaching the pre-selected minimum distance.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a side view in elevation illustrating a recreational vehicle equipped force applying apparatus in the form of a lift device according to a first exemplary embodiment of the present invention;

FIGS. 2(a) and 2(b) illustrate the force applying apparatus according to a first exemplary embodiment of the present invention respectively shown in fully collapsed and fully expanded positions;

FIGS. 3(a), 3(b) and 3(c) illustrate the force applying apparatus of FIGS. 2(a) and 2(b) without the protective boot therefore and respectively shown in a fully collapsed, intermediate and fully expanded positions;

FIG. 4 is a side view in partial cross-section showing the force applying apparatus of FIGS. 2(a) and 2(b) in the fully collapsed position;

FIG. 5 is an exploded perspective view showing the housing used with the force applying apparatus of FIG. 4;

FIG. 6 is a perspective view showing the spline assembly of the force applying apparatus of FIG. 4;

FIG. 7 is a top plan view, in partial cross-section, showing the engagement of the spline assembly of FIG. 6 with the housing of FIG. 5;

FIG. 8 is a side view in elevation and partial cross-section of a top portion of the spline assembly of FIG. 6 illustrating the keying of the shaft portion of the spline assembly of FIG. 6;

FIG. 9 is a perspective view, partially broken away, illustrating the first extendable member in the form of an acme screw used with the force applying apparatus of FIG. 4;

FIG. 10 is a perspective view, partially broken away, illustrating the lift gear used with the force applying apparatus of FIG. 4 which lift gear engages and drives the first extendable member shown in FIG. 9;

FIG. 11 is side view, partially exploded and partially in cross-section, showing a portion of the detent ring mounted on the top portion of the first extendable member that is illustrated in FIG. 9;

FIG. 12 is a perspective view of the second extendable member used with the force applying apparatus of FIG. 4;

FIG. 13 is a top view in elevation of the second extendable member illustrated in FIG. 12;

FIG. 14 is a side view in elevation showing the gated ring which mounts on the top of the second extendable member shown in FIG. 12 for purposes of interfacing with the detent assembly of FIG. 11;

FIG. 15 is a bottom plan view of the gated ring of FIG. 14;

FIG. 16 is a top plan view, partially broken away, depicting the interface between the second extendable member and the detent ring as illustrated in FIG. 11;

FIG. 17 is an exploded perspective view illustrating the foot assembly that is secured to the second extendable member of FIG. 12 used with the force applying apparatus of FIG. 4;

FIG. 18 is a perspective view of a representative mounting bracket that may be employed with the force applying apparatus of FIG. 4; and

FIG. 19 is a diagrammatic view of a second exemplary embodiment of the present invention employing three extendable sections.

### DETAILED DESCRIPTION OF THE EXEMPLARY EMBODIMENTS

The present invention generally relates to force a applying apparatus that either supports or moves a load relative to two locations. For example, the present invention may be used to apply force between two objects, between an object and a surface, between two surfaces, and the like. The present invention is described specifically with respect to a lifting apparatus such as a jack assembly, which supports or moves a load as part as a leveling system for a load, such as a recreational vehicle. However, it should be understood that, while this invention is described with respect to the support of a recreational vehicle, it should be understood that the invention has applications broader than just as such a jack or leveling assembly. Indeed, it may be used as a mechanical advantage device in any application needful of forces to be applied between two locations, as described above.

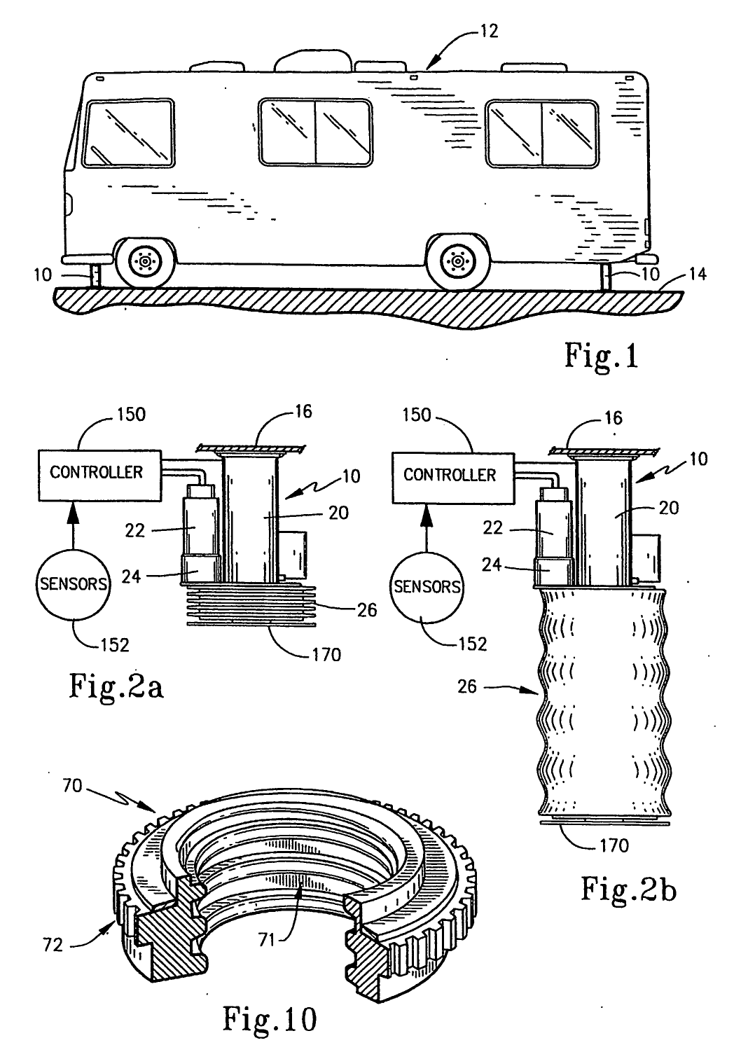

With reference first to FIG. 1, then, a pair of force applying apparatus 10 as shown mounted to a recreational vehicle 12 in order to support and level recreational vehicle 12 with respect to a support surface 14 on which recreational vehicle 12 is parked. It should be understood that the number of such apparatus may be selected for a particular application. In any event, a representative force applying apparatus 10 is illustrated in somewhat greater detail in FIGS. 2(a) and 2(b) where it may be seen that force applying apparatus 10 is secured and supported to a frame piece 16 which may be a portion of the recreational vehicle 12. However, it should be understood that frame piece 16 may be a mounting bracket or could be some other structure for which force applying apparatus is to apply a force or otherwise provide support.

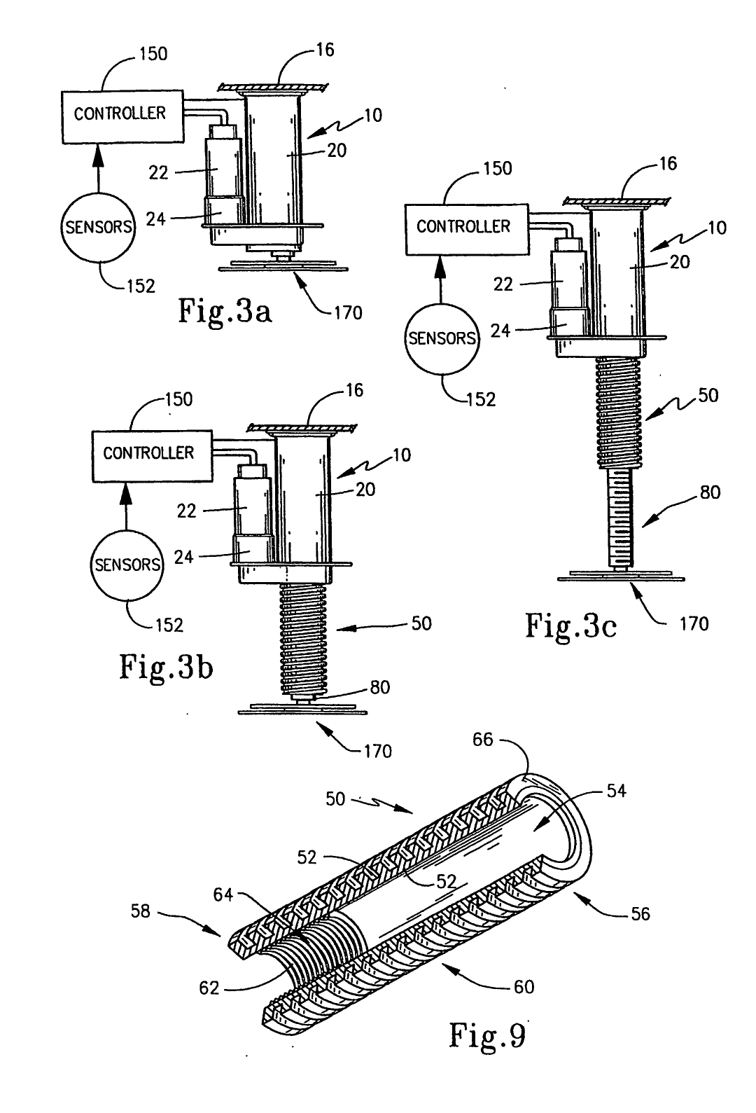

In FIG. 2(a) the force applying apparatus 10 is shown in a fully collapsed position and, in FIG. 2(b) force applying apparatus 10 is shown in a fully expanded position. With continued reference to FIGS. 2(a) and 2(b) along with reference to FIGS. 3(a), 3(b) and 3(c), it may be appreciated that force applying apparatus 10 includes a housing 20 which supports a drive in the form of a motor 22 which acts through a gear box 24 to move force applying apparatus 10 from a fully contracted position, as illustrated in FIGS. 2(a) and 3(a), through an intermediate position shown in FIG. 3(b) to a fully expanded position shown in FIGS. 2(b) and 3(c). Housing 20 may be constructed of any convenient material, such as, aluminum.

With reference to FIGS. 3(a)-3(c), it may be seen that force applying apparatus 10 includes a first extendable member 50 that is telescopically received in the interior of housing 20 and which is operative to move between a retracted position wherein the first extendable member 50 is telescopically received in the housing interior and in the extended position wherein the first extendable member 50 extends longitudinally outwardly of housing 20. Further, force applying apparatus 10 includes a second extendable member 80 that may be advanced between a contracted position wherein the second extendable member 80 is telescopically received in the interior of first extendable member 50 and which is operative to move to an expanded position wherein the second extendable member extends longitudinally outwardly of the first extendable member 50. A foot assembly 170 is shown attached to the distal or free end of second extendable member 80, this foot assembly 170 is described more thoroughly below. Moreover, as illustrated in FIGS. 2(a) and 2(b), a boot 26 in the form of an expanding accordion bellows is provided to protect the first extendable member 50 and the second extendable member 80, along with the drives therefor, against the ingress of dust, dirt and to resist other damage to the mechanism. Boot 26 is secured at one end to housing 20 and at the other end to foot assembly 170.

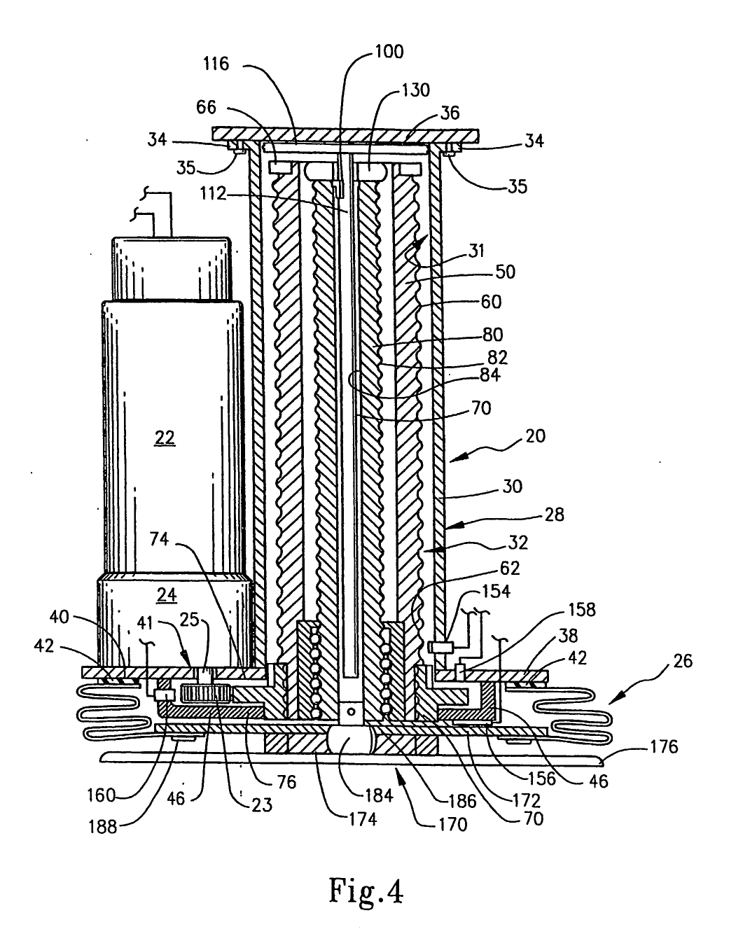

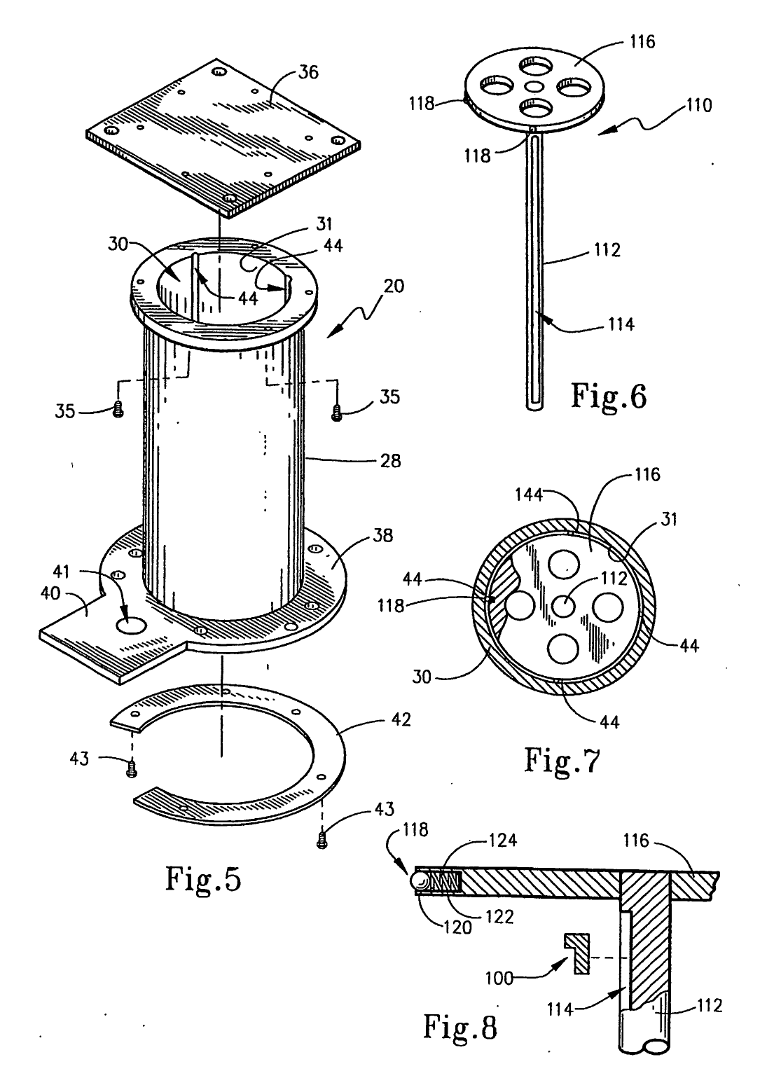

FIG. 4 is a cross-sectional view illustrating in greater detail the structure of force applying apparatus 10. With reference to FIG. 4 and with additional reference to FIG. 5, it may be seen that housing 20 includes an elongated housing body 28 and a lower housing portion 46. Housing body 28 is in the form of a hollow cylindrically tubular member having a surrounding sidewall 30 having an interior surface 31 and that forms an interior 32. An upper end of housing body 28 terminates in an annular flange 34 to which is mounted a mounting plate 36 by means of a plurality of screws, such as screws 35 illustrated in FIG. 5. A generally annular motor support plate 38 is mounted on an end of housing body 28 that is opposite flange 34. Motor support plate 38 includes a wing portion 40 to support motor 22 and gear box 24 with wing portion 40 being provided with a drive shaft opening 41 to receive drive shaft 25 from gear box 24. Drive shaft 25 supports a drive gear 23 which may be reversibly driven by reversible motor 22 in order to extend and retract the first and second extendable members. A retaining member 42 in the form of a substantially complete, annular ring may be mounted to the under side of motor support plate 38 in order to secure an edge of boot 26 to housing 20. This attachment is by means of screws 43, as is illustrated in FIG. 5. Retaining member 42 has a gap located at wing 40.

Housing 20 is sized and adapted to telescopically receive first extendable member 50 and second extendable member 80 along with a spline assembly 110 with spline assembly 110 introduced in greater detail in FIG. 6. In this figure and with further reference to FIGS. 4, 5 and 7, it may be seen that spline assembly 110 includes an elongated shaft portion 112 that is located along the central longitudinal axis of housing body 28 and which includes a longitudinally extending keyway channel 114. A head portion 116 is mounted on one end of shaft portion 112 and includes a plurality of radially outwardly projecting ball detents 118. As shown in FIG. 8, ball detents 118 each include a ball 120 and a biasing spring 122 received in radial bore 124 formed in the peripheral margin of head portion 116.

With reference again to FIG. 5 and with further reference to FIG. 7, it may be seen that ball detents 118 are adapted to engage longitudinally extending channels 44 formed on the interior surface 31 of sidewall 30. When ball detents 118 are received in their respective channels 44, spline assembly 110 may slide with relative ease in housing 20. However, rotation of spline assembly 110 within a housing 20 is resisted by the engagement of ball detents 118 and channels 44. However, should rotational force in excess of the amount selected by the strength of springs 122 be exceeded, head portion 116 and thus spline assembly 110 may rotate in housing 12 to provide a safety break away feature.

As noted above, first extendable member 50 is sized and adapted to be telescopically received in housing 20 so as to move between a retracted position, such as shown in FIG. 3(a) to a fully extended position such as shown in FIGS. 3(b) and 3(c). First extendable member 50 is best illustrated in FIG. 9 with first extendable member 50 being an acme screw formed of metal, such as aluminum. To this end, first extendable member 50 includes a hollow cylindrical body portion having a sidewall 52 that surrounds an open interior 54. Sidewall 52 has an outer surface extending between a first captured end 56 and a first free end 58 with this outer surface provided with first threads 60.

A threaded drive element in the form of a ball nut 62 is affixed to first extendable member 50 in the interior thereof proximate to first free end 58. Ball nut 62 has a threaded drive 64 as a second thread hitch which, in the exemplary embodiment, is different (i.e. greater) than the thread pitch of first thread 60. As should be understood by the ordinarily skilled person in this field of invention, ball nut 62 includes a plurality of ball bearings, shown in FIG. 4, which are received in the threaded drive 64 in order to provide a low friction threaded connection, as described below, with second extendable member 80.

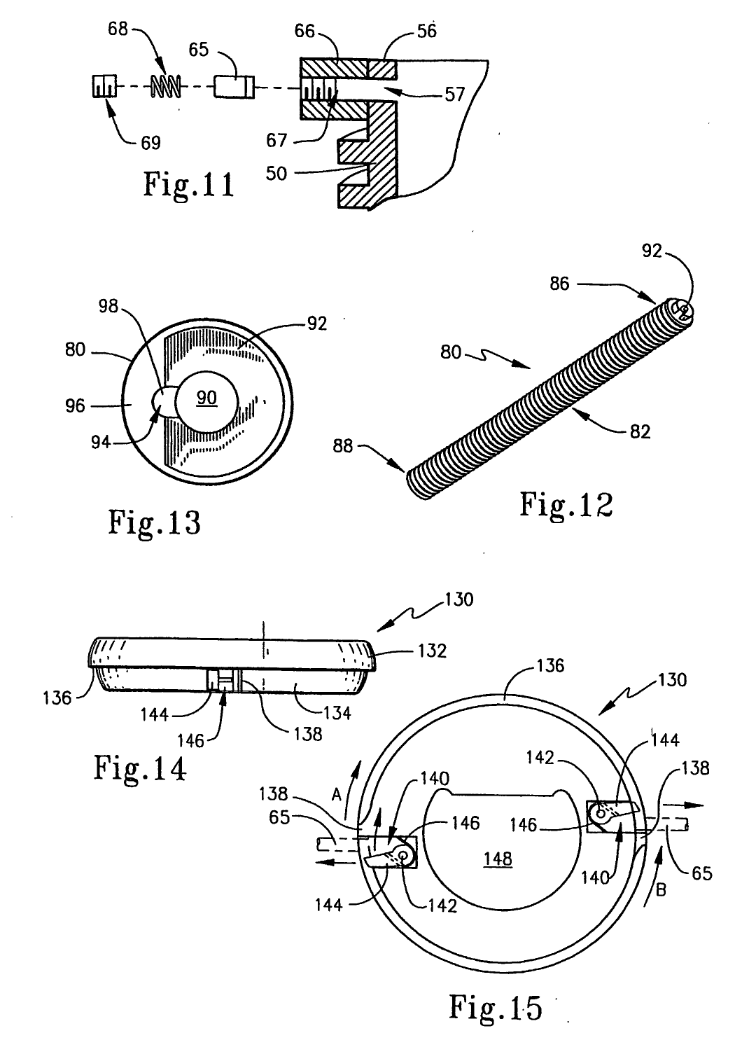

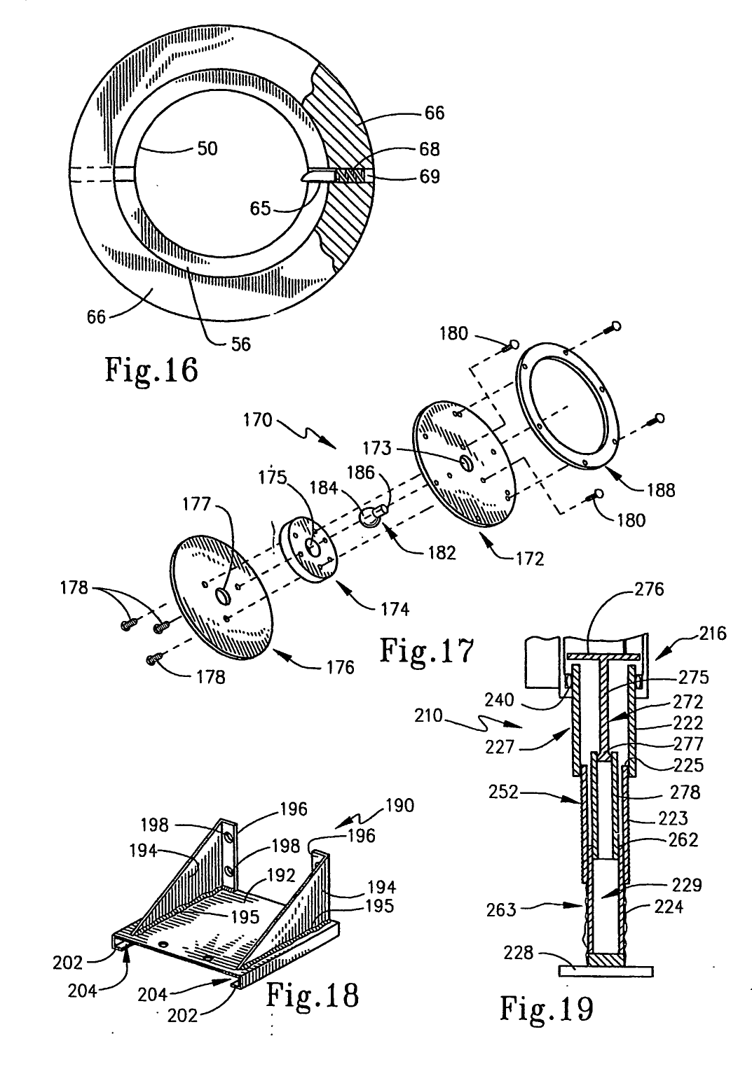

A detent ring 66 is mounted to first extendable member 50 exteriorly at a location captured in 56 with the structure of this detent ring being described below with respect to FIGS. 11 and 16. However, before turning to that description, it should be understood that first extendable member 50 may be moved between the retracted and extended positions by means of a lift gear in the form of a ring gear 70 illustrated in FIGS. 4 and 10. In these figures, it may be seen that ring gear 70 has interior lift threads 71 and exteriorly projecting drive threads 72. Drive threads 72 are adapted to engage drive gear 23. Further, as is shown in FIG. 4, ring gear 70 is supported by an annular bearing 74 and an annular thrust plate 76. Bearing 74 is thus positioned between ring gear 70 and motor support plate 78 while thrust plate 76 is positioned between ring gear 70 and an inverted cup shaped housing portion 46 that forms part of housing 20 and which is mounted on an opposite side of motor support plate 38 from housing body 28.

When motor 22 is activated, drive gear 23 is rotated through gear box 24 so that the lift gear, that is ring gear 70, is likewise rotated. Ring gear 70 may thus be reversibly driven. When this occurs, lift threads 71 act on first threads 60 to reciprocally drive first extendable member 50 between the retracted and extended positions, provided that first extendable member 50 is held rotationally stationary. First extendable member 50 is held in a stationary position by means of spline assembly 110 along with detent ring 66 and gated ring 130 described below.

First, however, the structure of second extendable member 80 may be appreciated with reference to FIGS. 4, 12 and 13. Here, second extendable member 80 is in the form of a ball screw again formed of any convenient material, such as steel or other metal, Second extendable member 80 has outer or second threads 82 which extend between a captured end 86 and a free end 88. These second threads 82 are on the cylindrical outer surface of sidewall 84 of second extendable member 80. Second extendable member further has a longitudinally extending, cylindrical passageway 90 that is sized and adapted to freely and telescopically receive shaft portion 112 of spline assembly 110 therein.

Captured end 86 of second extendable member 80 is provided with a D-shaped post 92 for purposes of mounting gated ring 130 thereto. A semi-circular cutout portion 94 is provided on shoulder 96 to create a seat 98 that extends between shoulder 96 and passageway 90, as illustrated in FIG. 13. With reference again to FIG. 8, this seat 98 is adapted to receive a key pin 100 that is also received in keyway channel 114 so as to key shaft portion 112 against rotation relative to second extendable member 80 while allowing reciprocal sliding motion of shaft portion 112 in passageway 90.

As noted above, first extendable member 50 and second extendable member 80 are interfaced by means of detent ring 66 and gated ring 130 with this mechanical structure best illustrated in FIGS. 11 and 14-16. In these figures, it may be seen that detent ring 66 is an annular piece that is mounted on captured end 56 of first extendable member 50. Detent ring 66 includes a pair of radially extending bores 67 that register with bores 57 formed in captured end 56. A detent rod 65 is received for reciprocal radial movement in bores 57 and 67 and is biased by means of a spring 68 held in position by set screws 69 that is threadably received in the outer end portion of bore 67. When mounted, as is shown in FIG. 16, detent posts 65 project radially inwardly a small distance into the interior of first extendable member 50 of captured end 56.

The structure of gated ring 130 may be more fully appreciated with reference to FIGS. 14-16. In these figures, it may be seen that gated ring 130 is annular in configuration and has an upper portion 132 that is slightly larger in diameter than a lower portion 134 so as a lip 136. A pair of ridges 138 extend longitudinally along lower portion 134 so as to provide limit stops, as described below. Moreover, lower portion 134 includes a pair of generally diametrically oppositely positioned bays 140 at each provided with a pivot pin 142 that pivotally mounts a gate pin 144 that is biased into a closed position, as is shown in FIG. 15, by means of a biasing springs 146. Moreover, gated ring 130 includes a D-shaped opening 148 that is sized and adapted for close fitting engagement on D-shaped post 92 of second extendable member 80. When second extendable member 80 is fully contracted so that it is telescopically received in first extendable member 50, as is shown in FIG. 4, detent posts 65 project into bays 140 and abut ridges 138 to prevent rotation of detent ring 66 in a direction of arrow “A” shown in FIG. 15. Since second extendable member 80 is prevented from rotation by means of spline assembly 110 and the keying of gated ring 130 to spline assembly 110, first extendable member 50 is correspondingly prevented from rotation. Thus, rotation of ring gear 70 in a first mode acts to advance first extendable member 50 from the retracted position shown in FIG. 4 to the extended position shown in FIG. 3(b). Upon full extension, detent ring 66 contacts ring gear 70, so that continued rotation of ring gear 70 in the first mode applies a rotational force on first extendable member 50. If this occurs, as illustrated in FIG. 15, ring gear 66 begins to rotate in the direction of arrow “B” so that relative rotation of the first and second extendable members may be permitted due to the release of engagement of detent post 65 acting on gate pin 144. Since spline assembly 110 holds second extendable member 80 against rotation, this rotation of first extendable member 50 acts to rotate ball nut 62 so that second extendable member 80 begins to advance from the contracted position shown in FIGS. 3(b) and 4 to the expanded position shown in FIG. 3(c). Of course, once detent post 65 has moved past gate pin 144 and has moved out of bays 140 so that second extendable member begins to advance toward the expanded position, there is no resistance to the rotation of first extendable member 50. Therefore, second extendable member 80 may be advanced up to its fully expanded position, if desired.

When it is desired to retract the force applying apparatus, that is, to move second extendable member from the expanded position to the contracted position and to move first extendable member from the extended position to the retracted position, motor 20 is reversed so as to reversibly drive ring gear 70 in an opposite direction. Since first extendable member 50 is freely rotatable, this rotation, acting through ball nut 62, serves to advance second extendable member 80 from the expanded position to the contracted position. As second extendable member 80 moves toward the fully telescoped, contracted position, gate pins 144 and detent posts 65 again come into play. With reference to FIG. 15, it should be appreciated that, during this motion, ring gear 66 is rotating in the direction of arrow “A” relative to gated ring 130. As detent posts 65 come into contact with gate pins 144, gate pins 144 pivot about pivot pins 142 against the force of biasing spring 146 until such time that detent pins 65 move past gate pins 144 and they spring back into position.

Here, it may also be appreciated that the force applied by springs 146 is less than the force applied by springs 68 acting on detent posts 65 such that, in a retraction mode, detent posts 65 easily move past gate pins 144 and into abutment with ridges 138 easier than the movement of detent posts 65 past gate pins 144 when rotation is in the direction of arrow “B”. This latter motion, of course, is controlled by the force applied by springs 68. This gate assembly helps ensure that second extendable member 80 is advanced fully into the contracted position before first extendable member 50 is locked against further rotation.

However, in this second mode of operation, when detent posts 65 move into bays 140 and against ridges 138, first extendable member becomes locked against rotation due to spline assembly 110. When first extendable member 50 becomes locked against rotation, further rotation of ring gear 70 in the second mode begins to advance first extendable member 50 (and the fully captured second extendable member 80) from the extended position to the retracted position.

With reference now to FIG. 17, it may be appreciated that foot assembly 170 is adapted to mount onto the free end 88 of second extendable member 80. To this end, foot assembly 170 includes a foot mounting plate 172, a spacer ring 174 and a foot plate 176 by means of screws 178 and 180. Foot mounting plate 172 includes a centrally located hole 173 located therein. Similarly, spacer ring 174 includes a centrally located hole 175 and footplate 176 includes a socket depression 177. A ball mount 182 includes a ball head 184 and a mounting post 186. Ball head 184 is positional to holes 173, 175 and depression 177 so as to be captured therein when foot mounting plate 172, spacer ring 174 and footplate 176 are secured together. Post 186 projects outwardly of this assembled structure to attach to the interior of second extendable member 80, as is shown in FIG. 4. This mounting allows foot assembly 170 to rotate about two axis of rotation due to the ball and socket structure. Moreover, with reference to FIGS. 4 and 17, it may be seen that a low end boot retaining ring 188 mounts on the top of foot mounting plate 172 so as to secure a second end of boot 46 to boot mounting plate 172. Lower boot retaining ring 188 and upper boot retaining ring 42 may be constructed of plastic or other suitable material.

A representative mounting bracket assembly 190 is best shown in FIG. 18. Here, bracket assembly 190 is shown to include a plate-like channel support 192 that is secured to a pair of support brackets 194 by weldments 195. Support brackets 194 are each triangular in shape and include a flange 196 provided with holes 198 that receive mounting bolts. Channel support 192 includes a pair of opposed, spaced apart flanges 202 that form facing channels 204 that face one another and provide a channel for receiving mounting plate 36 that is secured to housing 20 of the force applying apparatus 10.

While the above description with respect to FIGS. 1-17 employs a pair of extendable sections 50 and 80, it is possible to use more than two extendable sections. This is diagrammatically illustrated in FIG. 19 wherein a second exemplary embodiment of a force applying apparatus 210 is illustrated. Here, force applying apparatus 210 has a housing 216 that telescopically receives a first extendable member 222. A second extendable member 223 is then telescopically received in extendable member 222, and a third extendable member 224 is telescopically received in the interior of second extendable member 223. A drive gear 240 acts to rotatably drive first extendable member 222 to its furthest extension by way of threads 227, after which first extendable member 222 begins to rotate. Rotation of first extendable member 222 causes extension and contraction of second extendable member 223. When second extendable member 223 is fully extended, it starts to rotate. This rotation of second extendable member 223 causes extension of third extendable member 224. To this end, it should be understood that the lower end of first extendable member 222 is provided with threads 225 to interact with threads 252 of second extendable member 223. Likewise, second extendable member 223 has internal threads 262 on its outer end which interact with threads 263 on third extendable member 224.

In order to prevent rotation of third extendable member 224 so that it will extend and retract, a telescoping spline assembly 272 is provided. Telescoping spline assembly 272 includes a first spline 275 that has a head piece 276 similar to that described above. An end 277 of spline 275 is telescopically received in the hollow interior of second spline 278 which is telescopically received and keyed to the interior 229 of third extendable member 224. A lower foot 228 is provided on the extreme end of third extendable member 224 and is mounted thereto by a two-axis gimbal mount.

With respect to the embodiment shown in FIG. 19, it should be appreciated that rotation of drive gear 240 first acts to extend first extendable section 222 until it “bottoms out” after which first extendable member 222 begins to rotate. This rotation causes second extendable member 223 to advance to the fully extended position. When second extendable member 223 bottoms out, it also begins to rotate which then extends third extendable member 224. Reversal of gear 240 retracts lifting apparatus 210 by reversing the telescoping of the extendable members, as should be understood by the ordinarily skilled person in this art having the benefit of this explanation. Once again, head piece 276 has ball detents as a safety feature.

With reference to FIGS. 2(a), 2(b), 3(a)-3(c) and FIG. 4, it may also be appreciated that a suitable controller may be provided along with sensors to monitor this motion. Thus, as is shown in these figures, controller 150 selectively activates and deactivates motor 22 between its reversible modes. These sensors are diagrammed, at 152, in FIGS. 2(a), 2(b) and 3(a)-3(c), but are illustrated in greater detail in FIG. 4. In FIG. 4, a first proximity switch 154 is mounted in housing 20 proximate to a lower end thereof. First proximity switch 154 detects the presence of detent ring 66 when first extendable member 50 is moved to the fully extended position and communicates this information to controller 150. A contact switch 156 is provided to contact foot mounting plate 172 when first extendable member 50 is moved to the fully retracted position (since second extendable member is fully telescoped therein). This signal is likewise communicated to controller 150. A second proximity switch 158 extends through motor support plate 38 and monitors the position of ring gear 70. When second extendable member 80 is subjected to a compressive force, ring gear 70 becomes slightly elevated so that second proximity switch 158 detects this deflection and communicates the same to controller 150. Finally, switch 160 is located proximately to drive gear 23 and is operative to count the teeth of drive gear 23 thereby to provide a shaft encoding for the rotation of drive shaft 25.

While the above detailed description of the exemplary embodiments of the present invention have been provided in some detail. It should be appreciated that the present invention also concerns a method for applying the force between two locations. Broadly, this method includes a step of securing a housing at a first location wherein the housing telescopically receives a first extendable member and wherein the first extendable member telescopically receives a second extendable member. The method then includes the step of mechanically advancing the first extendable member at a first rate of extension from a retracted position within the housing to an extended position wherein the first and second extendable members extend axially outwardly of the housing. The method then includes the step of mechanically advancing the second extendable member at a second rate from a contracted position within the first extendable member to an expanded position wherein the second extendable member extends axially outwardly of the first extendable member. The first rate of advancement is faster than the second rate of advancement. This is accomplished, from the above-described structure, wherein the threads per unit length of the second threads is greater than the threads per unit length of the first threads.

This broad method may be undertaken wherein the step of advancing the first extendable member is completed before beginning the step of advancing the second extendable member. The method may include the step of monitoring the advancement of the second extendable member to determine if it makes contact with the second location. The step of advancing the second extendable member further may include the advancement of the second extendable member for a pre-determined distance after the second extendable member makes contact with the second location. The method may also include the step of monitoring the advancement of the second extendable member for resistance that occurs before the second extendable member has advanced toward the expanded position for a pre-selected minimum distance. The method then includes the step of disabling advancement of the second extendable member should resistance be detected before reaching the pre-selected minimum distance.

With respect to the latter process, it should be understood that the present invention therefore has certain safety features when used in conjunction with the various sensors and the controller described above. For example and for illustrative purposes only, where the one or more force applying apparatus 10 are mounted to a recreational vehicle, the approximate location of the support surface may be determined by the mounting location. The first extendable member is advanced to the extended position, as described above, and the second extendable member begins to be advanced toward the expanded position, also as described above. Should a resistance be encountered before the anticipated contact with the support surface, this could indicate the presence of another object or even a child or an animal. Should such contact occur before the anticipated location of the support surface, such contact is sensed by second proximity switch 158. Controller 150 then disables motor 20 and displays an alarm for the operator such that the operator is alerted to checking the force applying apparatus to observe any obstruction.

Assuming no obstruction is encountered, once the extension has occurred beyond a preset threshold, the contact of the foot assembly with the support surface is detected by second proximity switch 158. This signals controller 50 to start monitoring the rotation of drive gear 23 by means of switch 160 which helps the gear teeth thereon. Once contact is made, controller 150 directs motor 22 to continue advancement for a pre-selected distance which would correspond to elevating and leveling of the recreational vehicle, for example. These various parameters can be pre-set in controller 150.

Again, it should be understood that the present force applying apparatus has particular application to use with recreational vehicles for the support, elevation and leveling of the same when parked by the user. However, the present invention should not be considered to be limited to such applications since this extendable member can be used to apply force between any objects. It should be appreciated that this invention may be employed in other applications where controlled high force movement between two pieces is desired. Thus, for example, the lifting apparatus could be used on machinery, mechanical presses and the like, as a replacement for traditional hydraulic systems or other jack-type lifts. The host of other applications can readily be appreciated by the ordinarily skilled person in this field of invention.

From the foregoing, it should be appreciated that the lift apparatus according to the present invention can include threads having different pitches, as desired. For example, the first extendable members may be course threaded so that they will extend and contract relatively rapidly and with less lifting force. The threading of the second extendable member (or the third extendable member as the case may be) may be more fine so that extension of the second extendable member is less rapid but occurs with greater lifting force.

In tests, it has been found that the force applying apparatus 10 constructed according to the first exemplary embodiment can lift approximately 26,000 pounds utilizing a ⅓ horse power motor. At the same time, the force applying apparatus 10 is smaller in longitudinal dimension and lighter in weight then traditional hydraulic jack lifters. Moreover, through the construction of bracket assembly 100, lift apparatus 10 can be easily and simply installed on the beam of an RV vehicle by a single person and substantially less time then with existing apparatus.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

I claim:

1. Apparatus adapted to apply force, comprising:
(A) a housing having a housing interior;
(B) an elongated first extendable member and an elongated second extendable member respectively having first and second thread structures, said first and second extendable members telescopically disposed and movable with respect to one another and together telescopically received within said housing;
(C) a first threaded drive element having a first thread drive of a first thread pitch and operative to engage said first thread structure thereby to advance said first extendable member between an extended position and a retracted position relative to said housing;
(D) a second threaded drive element having a second thread drive of a second thread pitch and operative to engage said second thread structure thereby to advance said second extendable member between a contracted position wherein said second extendable member is telescopically received in said first extendable member and an expanded position wherein said second extendable member extends outwardly of said first extendable member; and
(E) a drive operative
(1) in a first mode to actuate said first and second threaded drive elements whereupon said first extendable member is advanced between the retracted position and the extended position and said second extendable member is advanced from the contracted position to the expanded position, and
(2) in a second mode to actuate said first and second threaded drive elements whereupon said first extendable member is advanced between the extended position and the retracted position and said second extendable member is advanced from the expanded position to the contracted position.

2. Apparatus according to claim 1 including a boot having a first boot end secured to said housing and a second boot end secured to said second extendable member.

3. Apparatus according to claim 1 including a foot member secured to an end of one of said first and second extendable members.

4. Apparatus according to claim 3 wherein said foot member is movable about at least two axes of motion.

5. Apparatus according to claim 1 including a detent assembly interfacing said first and second extendable members.

6. Apparatus according to claim 1 including a spline assembly including a shaft portion slideably engaging said second extendable member and a head portion interfacing with said housing and operative to resist rotation of said second extendable member relative to said housing.

7. Apparatus according to claim 6 wherein said head portion includes a head detent operative to permit rotational movement of said head relative to said housing upon a rotational force in excess of a selected magnitude.

8. Apparatus according to claim 1 wherein said drive is a reversible motor.

9. Apparatus according to claim 1 wherein said housing interior is generally cylindrical, said first extendable member sized and adapted to be telescopically received in the housing interior and including a first sidewall surrounding a first member interior, said first extendable member having a first sidewall having a cylindrical outer surface extending between inner and outer ends of said first extendable member with said first sidewall provided with first threads sized and adapted to engage the first thread drive.

10. Apparatus according to claim 9 wherein said second extendable member is sized and adapted to be telescopically received in the first member interior and including a second sidewall having a cylindrical outer surface provided with second threads sized and adapted to engage the second thread drive.

11. Apparatus according to claim 10 wherein said second threaded drive is disposed proximately to the outer end of said first extendable member whereby rotation of said first extendable member acts to advance said second extendable member between the expanded and contracted positions.

12. Apparatus according to claim 11 wherein said second threaded drive is a ball nut.

13. Apparatus according to claim 9 wherein said first threaded drive is a lift gear with internal threads having the first thread pitch.

14. Apparatus according to claim 1 wherein said first and second thread pitches are different from one another.

15. Apparatus according to claim 1 including an extension sensor operative to detect when said first extendable member is in the extended position.

16. Apparatus according to claim 1 including an contact sensor operative to detect when said first and second extendable members begin to apply a force on an object in excess of a threshold amount.

17. Apparatus according to claim 1 including a retraction sensor operative to detect when said first extendable member is in the retracted position.

18. Apparatus adapted to apply force, comprising:
(A) a housing including a housing sidewall surrounding a housing interior and first and second housing end portions;
(B) a lift gear disposed in said second housing end portion and including lift threads having a first thread pitch;
(C) an elongated first extendable member sized and adapted to be telescopically received in the housing interior and including a first sidewall surrounding a first member interior, said first sidewall having a cylindrical outer surface extending between first captured end and a first free end with said first sidewall provided with first threads sized and adapted to engage the lift threads on said lift gear;
(D) a threaded drive element disposed in the first member interior at a location proximate to the first free end thereof, said threaded drive element having a thread drive of a second thread pitch;
(E) an elongated second extendable member sized and adapted to be telescopically received in the first member interior, said second extendable member including a second sidewall having a cylindrical outer surface extending between a second captured end and a second free end with said second sidewall provided with second threads sized and adapted to engage the thread drive;
(F) a drive operative to rotate said lift gear whereupon:
(1) rotation of said lift gear in a first rotational direction acts to advance said first extendable member between a retracted position wherein said first extendable member is telescopically received in the housing interior and an extended position wherein said first extendable member extends longitudinally outwardly of said housing, and
(2) rotation of said lift gear in the first rotational direction when said first extendable member is in the extended position acts to rotate said first extendable member and said threaded drive element in the first rotational direction such that said second extendable member is advanced between a contracted position wherein said second extendable member is telescopically received in the first member interior and an expanded position wherein said second extendable member extends longitudinally outwardly of said first extendable member, and
(3) rotation of said lift gear in a second rotational direction when said first extendable member is in the extended position acts to rotate said first extendable member and said threaded drive element in the second rotational direction such that said second extendable member is advanced from the expanded position toward the contracted position, and
(4) rotation of said lift gear in the second rotational direction when said second extendable member is in the contracted position acts to advance said first extendable member from the extended position toward the retracted position.

19. Apparatus according to claim 18 wherein said second extendable member has a keyway extending longitudinally therein, and including a spline assembly including a head portion disposed in the housing interior and adapted for sliding movement therein and a shaft portion slidably received in the keyway and operative to resist rotation of said second extendable member relative to said housing.

20. Apparatus according to claim 19 wherein said head portion includes at least one ball detent operative to permit of said head relative to said housing upon a rotational force in excess of a selected maximum.

21. Apparatus according to claim 20 wherein said housing sidewall has at least one longitudinally extending groove formed interiorly of said housing, said groove sized and adapted to engage said ball detent.

22. Apparatus according to claim 19 including a boot having a first boot end secured to said housing and a second boot end secured to the second free end of said second extendable member.

23. Apparatus according to claim 19 including a foot member secured to the second free end of said second extendable member.

24. Apparatus according to claim 23 including a boot having a first boot end secured to said housing and a second boot end secured to said foot member.

25. Apparatus according to claim 23 wherein said foot member is movable about at least two axes of motion.

26. Apparatus according to claim 19 including a detent assembly interfacing said first and second extendable members.

27. Apparatus according to claim 26 wherein said detent assembly acts with a first force resisting disengagement of said first and second extendable members for movement of said second extendable member from the contracted position to the expanded position and acts with a second force permitting re-engagement of said first and second extendable members when said second extendable member is moved from the expanded position to the contracted position, the first force being greater than the second force.

28. Apparatus according to claim 27 wherein said detent assembly includes a spring-biased detent element on one of said first and second extendable members and a spring-biased detent gate on another of said first and second extendable members.

29. Apparatus according to claim 18 wherein said threaded drive is a ball nut.

30. Apparatus according to claim 18 wherein said first and second thread pitches are different from one another.

31. Apparatus according to claim 30 wherein said second thread pitch has a greater number of thread per unit length than said first thread pitch.

32. Apparatus according to claim 18 including an extension sensor operative to detect when said first extendable member is in the extended position.

33. Apparatus according to claim 18 including an contact sensor operative to detect when said first and second extendable members begin to apply a force on an object in excess of a threshold amount.

34. Apparatus according to claim 18 wherein said drive includes a is a reversible motor and a drive gear engaging said lift gear.

35. Apparatus according to claim 34 wherein said drive includes a drive gear engaging said lift gear and including a drive gear sensor operative to monitor rotation of said drive gear.

36. Apparatus adapted to apply force between an object and a surface, comprising:
(A) a housing adapted to secure to the object and including a housing sidewall surrounding a housing interior;
(B) a lift gear supported by said housing for rotational movement and including lift threads having a first thread pitch;
(C) an elongated first extendable member sized and adapted to be telescopically received in the housing interior and including a first sidewall surrounding a first member interior, said first extendable member having a first sidewall having a cylindrical outer surface extending between inner and outer ends of said first extendable member with said first sidewall provided with first threads sized and adapted to engage the lift threads on said lift gear;
(D) a threaded drive element disposed in the first member interior at a location proximate to the outer end portion of said first extendable member, said threaded drive element being internally threaded with drive threads of a second thread pitch different from said first thread pitch;
(E) an elongated second extendable member sized and adapted to be telescopically received in the first member interior and having a keyway extending longitudinally therein, said second extendable member including a second sidewall having a cylindrical outer surface provided with second threads sized and adapted to engage the drive threads of said drive element;
(F) a spline assembly including a head portion disposed in the housing interior and adapted for sliding movement therein and a shaft portion slidably received in the keyway whereby said second extendable member and said shaft are prevented from relative rotation, said spline assembly operative to resist rotation of said second extendable member relative to said housing;
(G) a detent assembly interfacing said first and second extendable members;
(H) a drive including a motor and a drive gear operative to rotate said lift gear whereupon:
(1) rotation of said lift gear in a first rotational direction acts to advance said first extendable member between a first retracted position wherein said first extendable member is telescopically received in the housing interior and a first extended position wherein said first extendable member extends longitudinally outwardly of said housing, and
(2) rotation of said lift gear in the first rotational direction when said first extendable member is in the extended position acts to rotate said first extendable member and said drive element such that said second extendable member is advanced between a second retracted position wherein said second extendable member is telescopically received in the first member interior and a second extended position wherein said second extendable member extends longitudinally outwardly of said first extendable member, and
(3) rotation of said lift gear in a second rotational direction when said first extendable member is in the first extended position acts to rotate said first extendable member and said drive element in the second rotational direction such that said second extendable member is advanced between the second extended position and the second retracted position, and
(4) rotation of said lift gear in the second rotational direction when said second extendable member is in the second retracted position acts to advance said first extendable member between the first extended position and the first retracted position.

37. Apparatus according to claim 36 including a drive gear sensor operative to monitor rotation of said drive gear.

38. Apparatus according to claim 36 including an contact sensor operative to detect when said first and second extendable members begin to apply a force on an object in excess of a threshold amount.

39. Apparatus according to claim 36 including a foot member secured to the second free end of said second extendable member and including a boot having a first boot end secured to said housing and a second boot end secured to said foot member.

40. Apparatus according to claim 36 wherein said detent assembly acts with a first force resisting disengagement of said first and second extendable members for movement of said second extendable member from the contracted position to the expanded position and acts with a second force permitting re-engagement of said first and second extendable members when said second extendable member is moved from the expanded position to the contracted position, the first force being greater than the second force.

41. Apparatus according to claim 40 wherein said detent assembly includes a spring-biased detent element on one of said first and second extendable members and a spring-biased detent gate on another of said first and second extendable members.

42. Lifting and leveling system adapted to support a vehicle relative to a support surface, comprising:
(A) at least one force applying apparatus including:
(1) a housing adapted to be secured to a vehicle and having a housing interior;
(2) an elongated first extendable member and an elongated second extendable member respectively having first and second thread structures, said first and second extendable members telescopically disposed and movable with respect to one another and together telescopically received within said housing;
(3) a first threaded drive element having a first thread drive of a first thread pitch and operative to engage said first thread structure thereby to advance said first extendable member between an extended position and a retracted position relative to said housing;
(4) a second threaded drive element having a second thread drive of a second thread pitch and operative to engage said second thread structure thereby to advance said second extendable member between a contracted positions wherein said second extendable member is telescopically received in said first extendable member and an expanded position wherein said second extendable member extends outwardly of said first extendable member;
(5) a drive operative
(a) in a first mode to actuate said first and second threaded drive elements whereupon said first extendable member is advanced between the retracted position and the extended position and said second extendable member is advanced from the contracted position toward the expanded position, and
(b) in a second mode to actuate said first and second threaded drive elements whereupon said first extendable member is advanced between the extended position and the retracted position and said second extendable member is advanced from the expanded position toward the contracted position;
(6) a first sensor operative to detect and generate a first signal when said first extendable member is in the extended position and a second sensor operative to detect and generate a second signal when said second extendable member contacts one of the support surface or an object on the support surface; and
(B) a controller responsive to said first and second signals to control operation of said drive.

43. A method of applying a force between two locations, comprising:
(A) securing a housing at a first location wherein said housing telescopically receives a first extendable member and wherein said first extendable member telescopically receives a second extendable member;
(B) mechanically advancing said first extendable member at a first rate of extension from a retracted position within said housing to an extended position wherein said first and second extendable members extend axially outwardly of said housing; and
(C) mechanically advancing said second extendable member at a second rate from a contracted position within said first extendable member to an expanded position wherein said second extendable member extends axially outwardly of said first extendable member, the first rate being faster than the second rate.

44. A method according to claim 43 wherein the step of advancing said first extendable member is completed before beginning the step of advancing said second extendable member.

45. A method according to claim 43 including the step of monitoring the advancement of said second extendable member to determine if it makes contact with the second location.

46. A method according to claim 45 including the step of advancing said second extendable member for a pre-determined distance after said second extendable member makes contact with the second location.

47. A method according to claim 43 including the step of monitoring the advancement of said second extendable member for resistance that occurs before said second extendable member has advanced toward the expanded position for a pre-selected minimum distance and including the step of disabling advancement of said second extendable member should resistance be detected before reaching the pre-selected minimum distance.
